(19) United States
(12) Patent Application Publication
(10) Pub. No.: US 2024/0014988 A1
(43) Pub. Date: Jan. 11, 2024

(54) TERMINAL

(71) Applicant: NTT DOCOMO, INC., Tokyo (JP)

(72) Inventors: Haruhi Echigo, Tokyo (JP); Hiroki Harada, Tokyo (JP); Daisuke Kurita, Tokyo (JP)

(73) Assignee: NTT DOCOMO, INC., Tokyo (JP)

(21) Appl. No.: 18/253,514

(22) PCT Filed: Nov. 20, 2020
(86) PCT No.: PCT/JP2020/043486

§ 371 Date: May 18, 2023

(51) Int. Cl. H04L 5/00; H04W 74/08

(52) U.S. Cl. CPC H04L 5/0092; H04W 74/0833

(57) ABSTRACT

A terminal (UE 200) receives from a radio base station (gNB 100) information including a first series length corresponding to a first subcarrier spacing and configure to a number greater than a first specified value, or information including a second series length corresponding to a second subcarrier spacing and configure to a number greater than a second specified value, and transmits to the radio base station a random access preamble having the first series length or the second series length corresponding to the received information.

### TECHNICAL FIELD

This disclosure relates to a terminal.

### BACKGROUND ART

The 3rd Generation Partnership Project (3GPP) has specified Long Term Evolution (LTE) and LTE-Advanced (hereinafter referred to as LTE, including LTE-Advanced) to further accelerate LTE. The 3GPP is also considering specifications for a successor system to LTE called 5G New Radio (NR) or Next Generation (NG).

For example, Release 16 of 3 GPP specifies a random access (RA) procedure equivalent to the procedure for accessing a radio base station from a terminal (User Equipment, UE).

The RA procedure is defined as a control flow that includes Msg1, in which a UE transmits a RACH (Random Access Channel) preamble to a radio base station, Msg2, in which the radio base station configures timing information and the like corresponding to the RACH preamble and transmits it as a RACH response to the UE, Msg3, in which the UE performs timing adjustment according to the timing information and transmits identification information and the like that can identify the UE to the radio base station, and Msg4, in which the radio base station notifies the UE that the conflict has been resolved by the identification information.

### CITATION LIST

### Non-Patent Literature

[Non-Patent Literature 1] 3GPP TS 38.331 V 16.0.0, 3rd Generation Partnership Project; Technical Specification Group Radio Access Network; NR; Radio Resource Control (RRC) protocol specification (Release 16), 3 GPP, March 2020

### SUMMARY OF INVENTION

According to Msg1 of the RA procedure, for example, when multiple UEs transmit the same RACH preamble using resources configured in the same time domain and the same frequency domain, a collision occurs at the radio base station that received the RACH preamble. Therefore, as the number of UEs accessing a single radio base station increases, the probability of occurrence of the aforementioned collisions tends to increase.

To reduce the probability of occurrence of the aforementioned collisions, for example, a method of increasing the resources in the time and frequency domains configured for Msg1 can be considered. However, the problem with adopting such a method is that the overhead (resources that cannot be used for data transmission and reception) increases.

Therefore, the following disclosure has been made in view of this situation, and the purpose is to provide a terminal that can efficiently use resources in Msg1 of the RA procedure.

One aspect of this disclosure is a terminal (UE 200) including a reception unit (radio signal transmission and reception unit 210) that receives from a radio base station (gNB 100) information including a first series length corresponding to a first subcarrier spacing and configure to a number greater than a first specified value, or information including a second series length corresponding to a second subcarrier spacing and configure to a number greater than a second specified value, and a transmission unit (radio signal transmission and reception unit 210) that transmits to the radio base station a random access preamble having the first series length or the second series length corresponding to the information received by the reception unit.

One aspect of this disclosure is a terminal (UE 200) including a reception unit that (radio signal transmission and reception unit 210) receives information from a radio base station (gNB 100) including candidates of a plurality of formats that can be used in random access, a control unit (control unit 270) that selects one format from among the candidates of the plurality of formats included in the information received by the reception unit, and a transmission unit (radio signal transmission and reception unit 210) that transmits a random access preamble corresponding to the one format selected by control unit to the radio base station.

One aspect of the disclosure is a terminal (UE 200) including a reception unit (radio signal transmission and reception unit 210) that receives a plurality of beams from a radio base station (gNB 100) that belong to one group that shares at least some of the resources available in random access, and a transmission unit (radio signal transmission and reception unit 210) that transmits a random access preamble corresponding to the resources of one of the plurality of beams received by the reception unit to the radio base station.

### BRIEF DESCRIPTION OF DRAWINGS

FIG. 1 is an overall schematic configuration diagram of a radio communication system 10.

FIG. 2 shows an example of gNB 100 generating three cells via three TRPs.

FIG. 3 is a functional block diagram of UE 200.

FIG. 4 shows an example of a UE 200 receiving beams from two cells (PCI #0 and PCI #1 cells) formed by the same gNB 100.

FIG. 5 shows a portion of the RACH-ConfigCommon information element specified in TS 38.331 (v 16.0.0).

FIG. 6 shows a portion of the Frame structure type 1 random access configuration for preamble formats 0-3 specified in TS 36.211 V 13.2.0.

FIG. 7 shows a portion of the RACH-ConfigGeneric information element specified in TS 38.331 (v 16.0.0).

FIG. 8 shows an example of the allocation of RACH resources based on the provisions of Release 15 of 3GPP.

FIG. 9 shows an example of the allocation method of RACH resources in Operation 3.

FIG. 10 shows an example of the allocation method of RACH resources in Operation 3.

FIG. 11 shows an example of the hardware configuration of the UE 200.

### MODES FOR CARRYING OUT THE INVENTION

Exemplary embodiments of the present invention are explained below with reference to the accompanying drawings. Note that, the same or similar reference numerals have been attached to the same functions and configurations, and the description thereof is appropriately omitted.

### (1) Overall Schematic Configuration of the Radio Communication System

FIG. 1 is an overall schematic diagram of a radio communication system 10 according to the present embodiment. The radio communication system 10 is a radio communication system according to 5G New Radio (NR) and includes a Next Generation-Radio Access Network 20 (Below: NG-RAN 20), and a terminal 200 (Below, UE 200). In addition, the radio communication system 10 supports at least one of the frequency bands in the Frequency Range (FR) 1 (410 MHz to 7.125 GHz) and FR2 (24.25 GHz to 52.6 GHz), and may support other frequency bands.

The NG-RAN 20 includes a radio base station 100 (Below: gNB 100). The specific configuration of radio communication system 10 including the number of gNBs and UEs is not limited to the example shown in FIG. 1.

The NG-RAN 20 actually includes multiple NG-RAN nodes, specifically, gNBs (or ng-eNBs), and is connected to a core network (5 GC, not shown) according to 5G. Note that the NG-RAN 20 and 5 GCs may simply be described as a network.

The gNB 100 is a radio base station according to 5G and performs radio communication according to UE 200 and 5G. In particular, in this embodiment, the gNB 100 allocates resources to deal with random access of the UE 200, configures Msg 1 of the RA procedure, and notifies the UE 200 of information including the configuration.

The gNB 100 and the UE 200 are capable of supporting Massive MIMO (Multiple-Input Multiple-Output) which generates a more directional beam BM by controlling radio signals transmitted from multiple antenna elements, carrier aggregation (CA) which uses multiple component carriers (CCs) bundled together, dual connectivity (DC) which communicates simultaneously between the UE and each of the two NG-RAN nodes, and Integrated Access and Backhaul (IAB) which integrates radio backhaul between radio communication nodes such as the gNB and radio access to the UE. The gNB 100 and the UE 200 also operate according to the RA procedure.

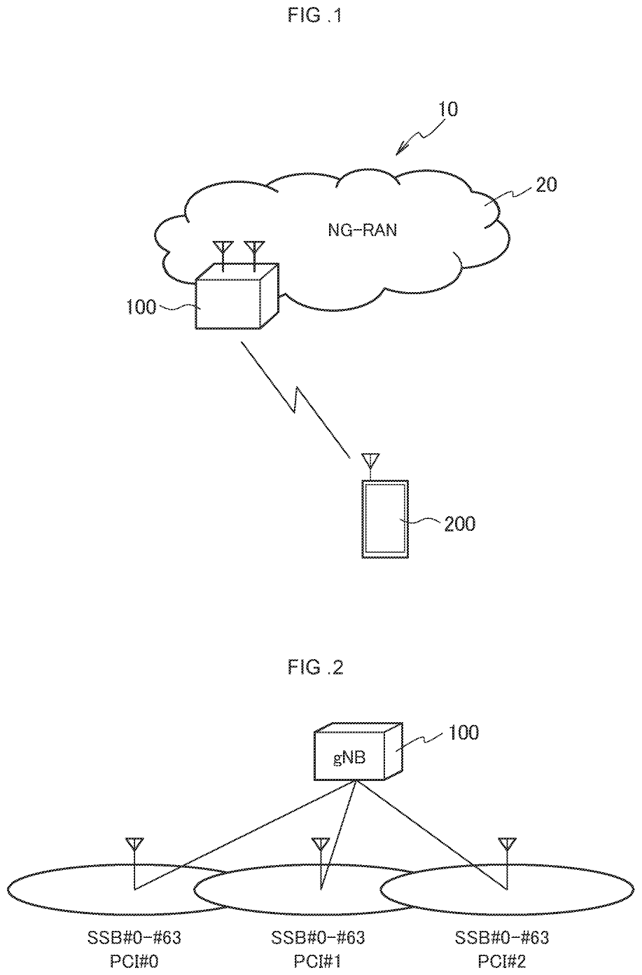

Here, the gNB 100 is equipped with multiple transmission and reception points (TRP) as shown in the figure. In this embodiment, the TRP is a unit of transmission and reception equipment that can form a cell and may be called a panel or simply an antenna. The number of TRPs is not limited to the example shown (three in the example in FIG. 1). FIG. 2 shows an example of gNB 100 generating 3 cells via 3 TRPs. That is, for the sake of explanation of the present embodiment, as shown in the figure, an example is shown in which 3 cells of physical cell ID (PCI) #1, PCI #2 and PCI #3 are formed. In the present embodiment, TRP refers to the following, and may be read as appropriate.
CORESET (Control Resource Set) Pool Index={0,1}
1st TCI (Transmission Configuration Index) state, 2nd TCI state
1st CDM (Code Division Multiplexing) group, 2nd CDM group (of PDSCH (Physical Downlink Shared Channel) DMRS (Demodulation reference signal))
1st PDSCH, 2nd PDSCH
RS port group, panel index, TCI-state/QCL (Quasi Co Location)/spatial-relation group index={0,1}

Note that the above is a case where there are two TRPs, and if there are more TRPs, the same configuration can be made.

Here, in NR, one cell can have up to 8/64 SSBs (SS/PBCH Blocks) in total in each of the frequency ranges FR 1/2. That is, the maximum number of SSBs is determined by the frequency band: 8 SSBs for FR1 between 410 MHz and 7.125 GHz and up to 64 SSBs for FR2 between 24.25 GHz and 52.6 GHz. Thus, under the current NR standard, a gNB can have up to a total of 8/64*several TRP SSBs. A single TRP can have up to 8/64 SSBs. The example in FIG. 2 shows that for each TRP, 64 SSBs (SSB index #0-#63) are used. Here, in this embodiment, the TRP can form a beam.

In beamforming, since the direction of radio waves from the TRP is narrowed and delivered, at certain times, the synchronization signal can be delivered only to a portion of the area that can be covered. For this reason, the standard assumes that the NR synchronization signal performs a process called beam sweeping, in which the beamformed signal is transmitted sequentially to the entire coverage area that can receive radio waves from the TRP. In this case, the SSB index is used to identify which beam the captured synchronization signal corresponds to in both the UE and gNB.

### (2) Function Block Configuration of Radio Communication System

Next, the functional block configuration of the radio communication system 10 will be described. Specifically, the functional block configuration of the UE 200 will be described.

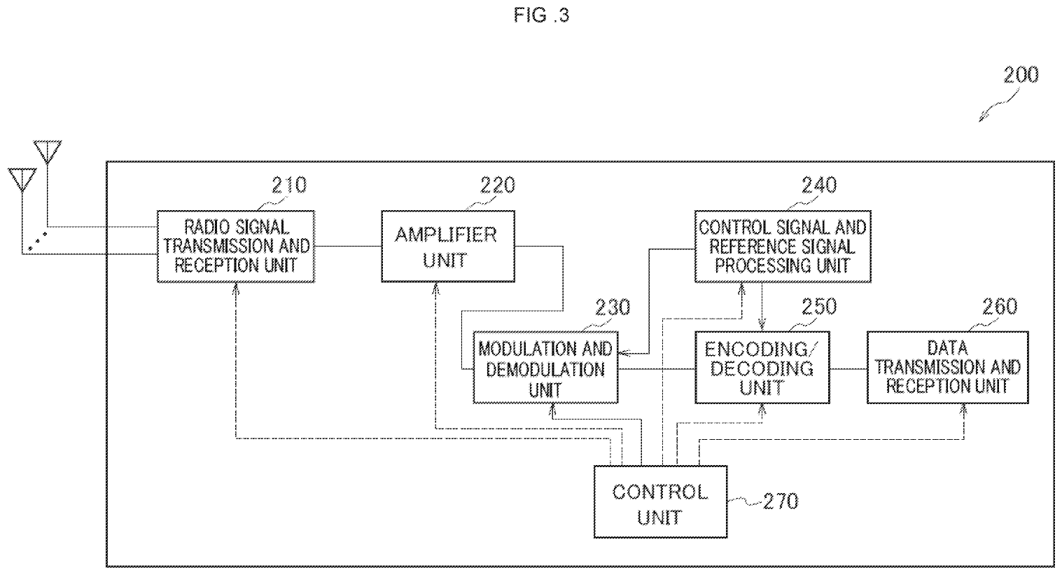

FIG. 3 is a functional block configuration diagram of the UE 200. As shown in FIG. 3, the UE 200 comprises a radio signal transmission and reception unit 210, an amplifier unit 220, a modulation and demodulation unit 230, a control signal and reference signal processing unit 240, an encoding/decoding unit 250, a data transmission and reception unit 260 and a control unit 270.

The radio signal transmission and reception unit 210 transmits and receives radio signals in accordance with NR. The radio signal transmission and reception unit 210 supports Massive MIMO, CA using multiple CCs bundled together, and DC communicating simultaneously between the UE and each of the 2 NG-RAN nodes.

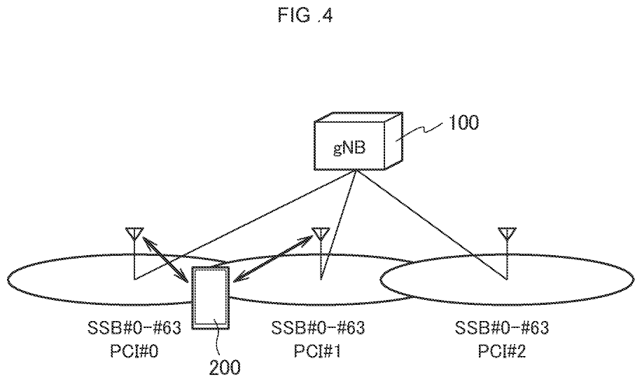

In this embodiment, the radio signal transmission and reception unit 210 receives beams from multiple cells formed by the same base station (gNB 100). Here, FIG. 4 shows an example in which the UE 200 receives beams from two cells (PCI #0 and PCI #1 cells) formed by the same gNB 100.

In this embodiment, the radio signal transmission and reception unit 210 functions as a reception unit and receives information (announcement information) transmitted from the gNB 100 prior to the Msg1 of the RA procedure, such as a MIB, etc. Also, in this embodiment, the radio signal transmission and reception unit 210 functions as a transmission unit and transmits a RACH preamble corresponding to the information notified (received) from the gNB 100 to the gNB 100.

The amplifier unit 220 is composed of a PA (Power Amplifier)/LNA (Low Noise Amplifier), etc. The amplifier unit 220 amplifies the signal output from the modulation and demodulation unit 230 to a predetermined power level. The amplifier unit 220 also amplifies the RF signal output from radio signal transmission and reception unit 210.

The modulation and demodulation unit 230 performs data modulation/demodulation, transmission power setting and resource block allocation for each predetermined communication destination (gNB 100 or another gNB, or each cell).

The control signal and reference signal processing unit 240 performs processing for various control signals transmitted and received by the UE 200 and processing for various reference signals transmitted and received by the UE 200.

Specifically, the control signal and reference signal processing unit 240 receives various control signals transmitted from the gNB 100 via a predetermined control channel, for example, upper layer signals, control signals such as RRC parameters, etc. The control signal and reference signal processing unit 240 also transmits various control signals toward the gNB 100 via a predetermined control channel.

The control signal and reference signal processing unit 240 also performs processing using a reference signal (RS) such as a demodulation reference signal (DMRS) and a phase tracking reference signal (PTRS).

DMRS is a known reference signal (pilot signal) between individual base stations and terminals for estimating the fading channel used for data demodulation. PTRS is a reference signal for individual terminals for estimating phase noise, which is a problem in high frequency bands.

In addition to DMRS and PTRS, reference signals include Reference Signal for RLM (RLM-RS), Channel State Information-Reference Signal (CSI-RS) and Sounding Reference Signal (SRS).

In addition, channels include control channels and data channels. Control channels include PDCCH (Physical Downlink Control Channel), PUCCH (Physical Uplink Control Channel), RACH (Downlink Control Information (DCI) including Random Access Channel, Random Access Radio Network Temporary Identifier (RA-RNTI)), and Physical Broadcast Channel (PBCH).

Data channels include PDSCH (Physical Downlink Shared Channel), and PUSCH (Physical Downlink Shared Channel). Data means data transmitted through a data channel.

The encoding/decoding unit 250 performs data division/concatenation and channel coding/decoding for each predetermined communication destination (gNB 100 or another gNB, or each cell).

Specifically, the encoding/decoding unit 250 divides data output from the data transmission and reception unit 260 into predetermined sizes and performs channel coding on the divided data. The encoding/decoding unit 250 also decodes the data output from the modulation and demodulation unit 230 and concatenates the decoded data.

The data transmission and reception unit 260 transmits and receives protocol data units (PDU) and service data units (SDU). Specifically, the data transmission and reception unit 260 performs assembly/disassembly of PDUs/SDUs in multiple layers (Media access control layer (MAC), radio link control layer (RLC), and packet data convergence protocol layer (PDCP), etc.). The data transmission and reception unit 260 also transmits a hybrid automatic repeat request (ARQ). Note that the data transmission and reception unit 260 may perform data error correction and retransmission control based on the hybrid ARQ.

The control unit 270 controls each functional block that makes up the UE 200. Especially, in the present embodiment, the control unit 270 performs the operation related to Msg 1 of the RA procedure based on the information notified from the gNB 100.

### (3) Operation of Radio Communication System

Next, the operation of radio communication system 10 will be described. Specifically, the operation related to Msg 1 in the RA procedure will be described.

### (3.1) Schematic Operation

Based on the radius (size) of the cell formed by the TRP and the number of UEs 200 accessing the cell, the gNB 100 configures the usable number of RACH preambles in the cell and notifies the UE 200 of the usable number of the configured RACH preambles.

The gNB 100 configures the format of the RACH preamble that can be used in the cell formed by the TRP and notifies the UE 200 of the format of the configured RACH preamble.

The gNB 100 allocates one or more PRACH (Physical Random Access Channel) slots per RACH period as resources to support random access of the UE 200. The gNB 100 also allocates a RACH occasion to transmit a RACH preamble in one PRACH slot. In this disclosure, the RACH occurrence may be read as a time domain and frequency domain resource. In addition, the gNB 100 notifies the UE 200 of the configurations related to the RACH period and RACH occurrence using the upper-layer signal.

The UE 200 transmits the RACH preamble corresponding to the information notified (received) from the gNB 100 to the gNB 100 in Msg 1 of the RA procedure.

### (3.2) Example of Operation

Next, the operation related to Msg 1 of the RA procedure in this disclosure is described.

### (3.2.1) Operation Example 1

In this operation example, the PRACH Sub Carrier Spacing (SCS) specified in Release 15 of 3GPP supports a longer sequence length than the RACH preamble sequence lengths (839 and 139) specified in Release 15 of 3GPP, so that the maximum number of available RACH preambles per cell can be configured to 65 or more. In Release 15 of 3GPP, for example, the RACH preamble sequence length is configured to 139 when the SCS is either 15 kHz, 30 kHz, 60 kHz or 120 kHz. In Release 15 of 3GPP, for example, the RACH preamble sequence length is configured to 839 when the SCS is either 1.25 kHz or 5 kHz.

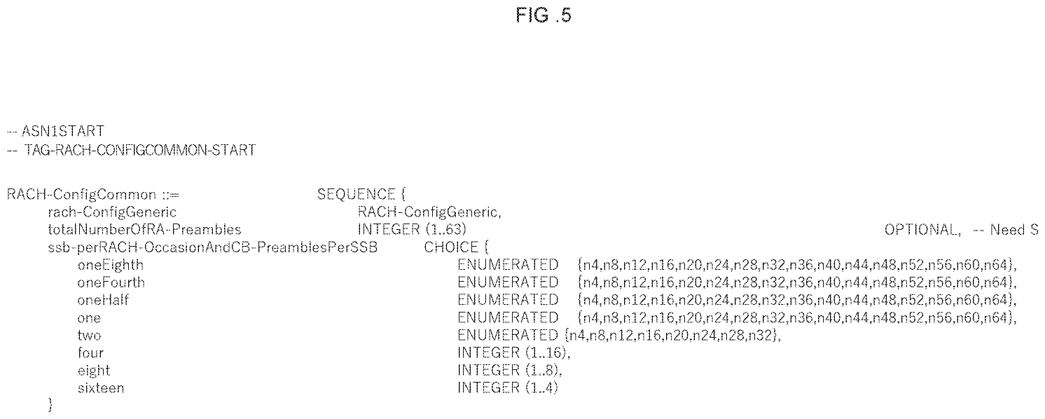

In this operation example, for example, in the total number of RA Preambles included in the RACH-ConfigCommon information element (see FIG. 5), which is an information element described in Non-Patent Literature 1, the maximum number of RACH preambles per cell is configured to 65 or more, and the maximum number of RACH preambles that have been configured is notified from gNB 100 to UE 200. FIG. 5 is a diagram showing a part of the RACH-ConfigCommon information element specified in TS 38.331 (v 16.0.0).

In this working example, for example, the 0 Correlation Zone (ZCZ), the sequence length of the RACH preamble, and the value of the first root index available in the cell to be accessed can all be reported from gNB 100 to UE 200. Note that ZCZ is a value indicating the lower limit of the cyclic shift interval and is also a value reported by signaling in the upper layer. Also, the root index is a value indicated from the upper layer according to the prach-RootSequenceIndex or rootSequenceIndex-BFR described in TS 38.211 V 16.0.0.

In this operation example, the UE 200 may recognize the number of cyclic shifts available for each root index based on the ZCZ and determine the number of available RACH preambles at one root index based on the number of recognized cyclic shifts. In this operation example, the number of available RACH preambles at one root index may be directly reported from the gNB 100 to the UE 200, not limited to the number obtained by the UE 200.

In this operation example, the UE 200 may recognize the number (range) of available root indexes in the cell to be accessed according to the value of the quotient and remainder obtained by dividing the maximum available number of RACH preambles by the available number of RACH preambles at one root index.

Specifically, in this operation example, if the value of the root index notified by gNB 100 is a, the quotient obtained by the above operation is p, and the remainder obtained by the above operation is 0, the UE 200 may recognize that p root indexes from a to a+p−1 are available in the cell to be accessed. In this operation example, if the value of the root index notified by gNB 100 is a, the quotient obtained by the above operation is p, and the remainder obtained by the above operation is a number other than 0, the UE 200 may recognize that (p+1) root indexes from a to a+p are available in the cell to be accessed.

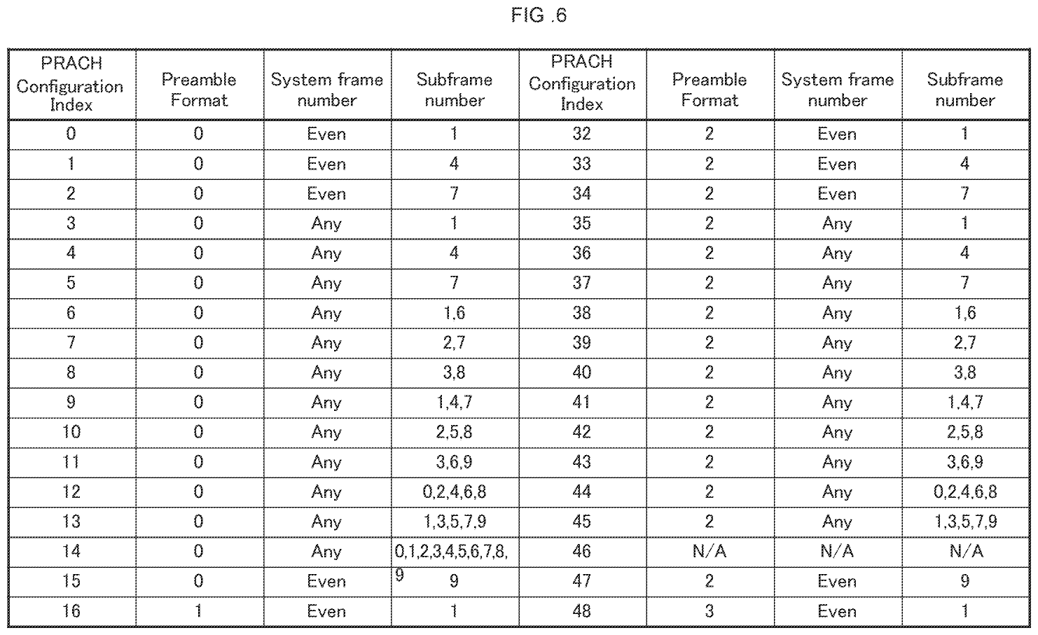

In this operation example, either of the following methods can be used when notifying the sequence length of the RACH preamble. FIG. 6 shows a portion of the frame structure type 1 random access configuration for preamble formats 0-3 specified in TS 38.211 (or TS 36.211 equivalent).
(Alt. 1-1) A new table associated with a Preamble format with a sequence length longer than that of the Preamble format specified in an existing table such as FIG. 6 can be configured and the new table can be optionally selected. In such a case, when the new table mentioned above is selected, gNB 100 can inform UE 200 that a sequence length longer than that of the RACH preamble specified in Release 15 of 3 GPP is available.
(Alt. 1-2) A new PRACH Configuration Index associated with a Preamble format having a sequence length longer than that of the Preamble format specified in an existing table such as FIG. 6 can be added to the existing table. In such a case, when the new PRACH Configuration Index mentioned above is selected, the gNB 100 can inform the UE 200 that a series length longer than that of the RACH preamble specified in Release 15 of 3 GPP is available.
(Alt. 1-3) Some of the existing Preamble formats specified in existing tables such as FIG. 6 can be replaced with a new Preamble format with a series length longer than that specified in Release 15 of 3 GPP. In such a case, when the new Preamble format mentioned above is selected, gNB 100 can inform UE 200 that a series length longer than that of RACH preamble specified in Release 15 of 3 GPP is available.

In this operation example, the UE 200 may be configured to receive from gNB 100 (in radio signal transmission and reception unit 210) information (MIBs, etc.) containing a first series length corresponding to either 15 kHz, 30 kHz, 60 kHz or 120 kHz SCS and configure to a number greater than the first specified value (139), or information (MIBs, etc.) containing a second series length corresponding to either 1.25 kHz or 5 kHz SCS and configure to a number greater than the second specified value (839), and to transmit to gNB 100 (from radio signal transmission and reception unit 210) a random-access preamble with the first or second series length corresponding to the received information.

According to this operation example, the number of available preambles in one RACH occurrence can be increased. Therefore, according to this operation example, even when the number of RACH occurrences is limited to a small number, the occurrence probability (occurrence frequency) of collisions in Msg1 of the RA procedure can be reduced. That is, according to this operation example, resources can be efficiently utilized in Msg1 of the RA procedure.

According to this operation example, a large number of UEs 200 can be accommodated in one gNB 100 by configuring a series length longer than that of the RACH preamble (839 and 139) specified in Release 15 of 3 GPP.

### (3.2.2) Operation Example 2

In this operation example, multiple RACH preamble format candidates available in the cell are configured or derived, the multiple RACH preamble format candidates are notified before Msg1 of the RA procedure, and one of the multiple RACH preamble format candidates is selected. In this operation example, the multiple RACH preamble format candidates need only be configured or derived with at least one of the series lengths different from each other and the number of repetitions different from each other.

In this operation example, the gNB 100 needs only to configure or derive the multiple RACH preamble format candidates by one of the following methods.
(Alt. 2-1-1) All of the predetermined N (N≥2) RACH preamble formats need only be explicitly configured as RACH preamble format candidates.
(Alt. 2-1-2) One of the N predefined RACH preamble formats may be explicitly configured as a candidate for the RACH preamble format. In addition, candidates for one or more other RACH preamble formats may be derived based on (N−1) other than the RACH preamble format configured as a candidate and the conditions specified in the specification.
Multiple candidates for RACH preamble formats may be derived based on (Alt. 2-1-3) N predefined RACH preamble formats and the conditions specified in the specification.

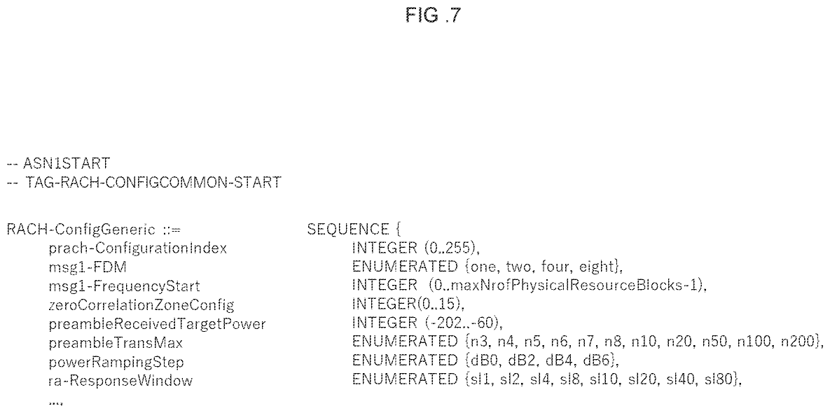

In this operation example, M candidates for RACH preamble formats can be explicitly configured by providing M (1≤M≤N) prach-ConfigurationIndex as configuration items (parameters) in the RACH-ConfigGeneric information element (see FIG. 7), which is an information element described in Non-Patent Literature 1, for example. FIG. 7 is a diagram showing a part of the RACH-ConfigGeneric information element specified in TS 38.331 (v 16.0.0).

Also, in this example of operation, for example, by changing or deleting the above prach-Configuration Index and tying only the information about the RACH preamble format to a separate signal or resource, M candidates for the RACH preamble format can be explicitly configured (and notified) from the combination of the prach-Configuration Index and the information about the additional RACH preamble format.

In this example of operation, the “conditions specified in the specification” above need only be conditions related to parameters in N RACH preamble formats.

In this example of operation, in the case of (Alt. 2-1-2) above, gNB 100 may derive candidates for RACH preamble formats by applying the same values of some parameters in one RACH preamble format configured as candidates to one or more RACH preamble formats out of the (N−1) RACH preamble formats above. Specifically, gNB 100 may derive candidates for RACH preamble formats by applying, for example, the same values of SCS in one RACH preamble format configured as candidates to one or more RACH preamble formats out of the (N−1) RACH preamble formats above.

In this working example, in the case of (Alt. 2-1-2) above, gNB 100 may derive candidates for RACH preamble formats by applying values lower or higher than the values of some parameters in one RACH preamble format configured as candidates to one or more RACH preamble formats out of the (N−1) RACH preamble formats above. Specifically, gNB 100 may derive candidates for RACH preamble formats by applying, for example, a series length shorter or longer than the series length in one RACH preamble format configured as a candidate to one or more RACH preamble formats out of the (N−1) RACH preamble formats above. Alternatively, gNB 100 may derive candidates for RACH preamble formats by applying, for example, fewer or more number of repetitions than the number of repetitions in one RACH preamble format configured as a candidate to one or more RACH preamble formats out of the (N−1) RACH preamble formats above.

In this operation example, the gNB 100 may notify the UE 200 of multiple RACH preamble format candidates configured or derived by the above method using, for example, information elements such as RACH-ConfigGeneric information elements.

In this operation example, in the case of the above (Alt 2-1-1), the gNB 100 may notify the UE 200 of parameters having multiple candidate values such as, for example, sequence length and number of repetitions.

In this operation example, the gNB 100 may notify the UE 200 of information necessary for selecting one of the multiple RACH preamble format candidates. Specifically, the gNB 100 may notify the UE 200 of, for example, at least one of the thresholds for SS-RSRP (Synchronization Signal-Reference Signal Received Power) and for parameters related to the capability of the UE 200.

In this example of operation, the gNB 100 may notify the information required for the selection of one of the multiple RACH preamble format candidates by associating it with each of the multiple RACH preamble format candidates. In this example of operation, the gNB 100 may notify the information required for the selection of one of the multiple RACH preamble format candidates by associating it with a parameter having multiple candidate values, such as the sequence length and the number of repetitions.

In this operation example, if the gNB 100 can transmit multiple System Information Blocks (SIBs) containing different notification information with different beams, the gNB may include in the notification information a plurality of RACH preamble format candidates different from each other in the beam transmitted to the cell edge and the beam transmitted to the cell center and notify the UE 200. In addition, if such notification is made, the UE 200 may select one format from among the multiple RACH preamble format candidates included in the notification information (received) from the gNB 100 in Msg 1 of the RA procedure and transmit the RACH preamble corresponding to the selected one format to the gNB 100.

In this operation example, the UE 200 may select one format from among the multiple RACH preamble format candidates included in the information notified (received) from the gNB 100 based on the measurement result obtained by measuring the value indicating the communication status with the gNB 100 and transmit the RACH preamble corresponding to the selected one format to the gNB 100. Specifically, the UE 200 may acquire the measurement result by measuring the Reference Signal Received Power (RSRP) at the time of receiving the downlink reference signal transmitted from the gNB 100, such as the SSB, etc., and select one format from among the multiple RACH preamble format candidates based on the comparison result between the acquired measurement result and a predetermined threshold. In this case, the value configured by the gNB 100 may be used as the predetermined threshold mentioned above, or the value specified in the specification may be used.

In this operation example, the UE 200 may select one format from among the candidates of the multiple RACH preamble formats included in the information notified (received) from the gNB 100 based on the capability information indicating its own capability (UE capability), and transmit the RACH preamble corresponding to the selected one format to the gNB 100. Specifically, the UE 200 may select one format from among the candidates of the multiple RACH preamble formats based on the capability information indicating at least one capability that can affect the coverage of the gNB 100, such as, for example, the transmit power it supports, the transmit bandwidth it supports, and the number of antennas it has.

In this operation example, one format may be selected from among the candidates of multiple RACH preamble formats by a combination of multiple methods among the methods described above.

In this operation example, the gNB 100 may be able to identify one format used for transmission of the RACH preamble by the UE 200 among the candidates of multiple RACH preamble formats. Also, in this operation example, any of the following methods may be used as a method for identifying one format used for transmission of the RACH preamble by the UE 200.
(Alt. 2-2-1) In each RACH occurrence, the use or non-use of all RACH preamble format candidates may be detected. In such cases, restrictions corresponding to each RACH occurrence may not be provided when configuring or deriving RACH preamble format candidates.
(Alt. 2-2-2) At the time of configuring or deriving RACH preamble format candidates, a resource (RACH occurrence) may be associated with the RACH preamble format available for that resource. Specifically, for example, a RACH preamble format may be associated for each SSB index or for each group with multiple SSB indexes. Or, for example, the RACH preamble format could be tied to each resource in the time domain or to each resource in the frequency domain.

In this operation example, the UE 200 only needs to be configured to receive information from the gNB 100 (in radio signal transmission and reception unit 210) containing candidates of multiple formats available for random access, to select one format (in control unit 270) among the candidates of the multiple formats included in the received information, and to send the random access preamble corresponding to that one format to the gNB 100 (from radio signal transmission and reception unit 210).

According to this operation example, by configuring or deriving the candidates of the multiple RACH preamble formats so that the UE 200 located at the cell edge uses the RACH preamble format with wide PRACH coverage, when housing a large number of UEs 200 in one gNB 100, the probability of occurrence (frequency of occurrence) of collisions in Msg 1 of the RA procedure can be reduced while the amount of resources used. That is, according to this operation example, resources can be efficiently utilized in Msg 1 of the RA procedure.

According to this operation example, a short preamble can be configured or derived as a candidate of the RACH preamble format in the beam (SSB) transmitted to the cell edge. In such a case, the PSD (Power Spectral Density) can be secured by narrowing the bandwidth without increasing the total transmission power.

According to this operation example, a long preamble can be configured or derived as a candidate of the RACH preamble format in the beam (SSB) transmitted to the cell center. In such a case, the maximum number of UEs 200 in 1 gNB 100 can be secured.

### (3.2.3) Operation Example 3

In this example, it is sufficient to integrate multiple beams (SSB) as a group and to allow multiple beams (SSB) included in the group to share the same RACH resource (RACH preamble and RACH occurrence).

### (3.2.3.1) Operation Example 3-1

In this example of operation, the gNB 100 may integrate multiple beams (SSB) as a group by configuring a parameter indicating the number of beams (SSB) sharing a RACH resource. Specifically, the gNB 100 may integrate multiple beams (SSB) as a group based on the operation result (the value of the remainder) obtained by performing the operation with the value of the SSB index assigned to each beam as the dividend when, for example, the divisor in the remainder operation is configured as the above parameter.

In this operation example, any of the following methods can be used as the method for allocating RACH resources to multiple beams (SSB) belonging to one group.
(Alt. 3-1-1) RACH resources may be allocated so that all beams belonging to one group (SSB) share RACH preamble and RACH occurrence.
(Alt. 3-1-2) RACH resources may be allocated so that multiple beams belonging to one group (SSB) have shared resources that share RACH preamble and RACH occurrence, and dedicated resources that are dedicated to either RACH preamble or RACH occurrence.

In the case of (Alt. 3-1-2) above, for example, one RACH resource group may be explicitly configured in the prach-ConfigurationIndex and msg1-FDM of the RACH-ConfigGeneric information element (see FIG. 7), which is an information element described in Non-Patent Literature 1, the ratio of shared resources to dedicated resources in the one RACH resource group may be configured, and the one RACH resource group may be divided based on the ratio. Or, in the case of (Alt. 3-1-2) above, for example, the RACH resource group for shared resources and the RACH resource group for dedicated resources may be separately configured in the prach-ConfigurationIndex and msg1-FDM of the RACH-ConfigGeneric information element (see FIG. 7), which is an information element described in Non-Patent Literature 1.

In the case of (Alt. 3-1-2) above, when the UE 200 determines that the RSRP of one beam (SSB) among the multiple beams (SSB) belonging to the same group is high on the basis of the RSRP of the other beam (SSB), in order to prevent interference, the RACH preamble may be transmitted using the RACH occurrences of the dedicated resource instead of the RACH occurrences of the shared resource. In determining the RSRP above, either the absolute value of the RSRP or the difference value from the reference value of the RSRP may be used as the threshold applied to the RSRP of the other beam (SSB) above.

In the above case of (Alt. 3-1-2), when the UE 200 determines that the number of retransmissions of the RACH preamble exceeds the threshold after failing to receive the RAR (Random Access Response) from the gNB 100, it may send the RACH preamble using the RACH occurrences of the dedicated resource instead of the RACH occurrences of the shared resource.

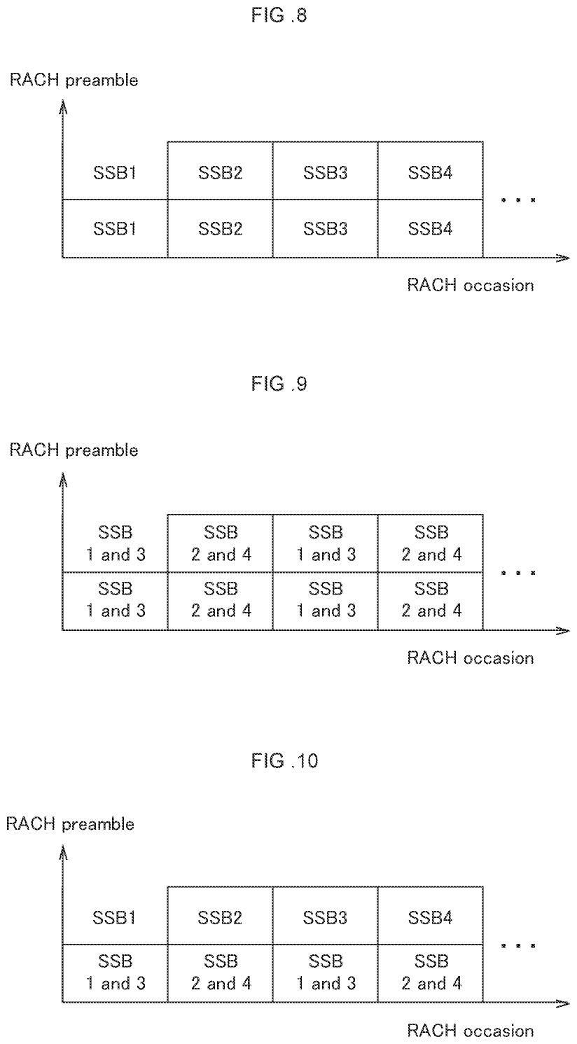

Here, according to the provisions of Release 15 of the 3 GPP, the RACH preamble and the RACH occurrence are reserved by one beam (SSB) because, for example, the RACH resource is allocated as shown in FIG. 8. FIG. 8 shows an example of the allocation of the RACH resource according to the provisions of Release 15 of the 3 GPP.

In contrast, in the case of the above (Alt. 3-1-1), for example, by allocating the RACH resource as shown in FIG. 9, the RACH preamble and RACH occurrence can be shared by two beams (SSB). FIG. 9 is a diagram showing an example of the RACH resource allocation method in operation example 3.

In the case of the above (Alt. 3-1-2), for example, by allocating the RACH resource as shown in FIG. 10, it is possible to provide a resource that occupies the RACH preamble in one beam (SSB) and to provide a resource that shares the RACH preamble and RACH occurrence in two beams (SSB). FIG. 10 shows an example of the RACH resource allocation method in operation example 3.

In this operation example, the UE 200 only needs to be configured to receive multiple beams from the gNB 100 (in radio signal transmission and reception unit 210) that belong to one group that shares at least some of the resources available in random access, and to transmit a random access preamble corresponding to the resource of one of the multiple beams to the gNB 100 (from radio signal transmission and reception unit 210).

According to this operation example, even if the gNB 100 receives multiple RACH preambles corresponding to different multiple beams (SSB) transmitted from the UE 200 in space division multiplexing with the same resource, the multiple RACH preambles can be detected individually. Therefore, according to this operation example, when accommodating a large number of UEs 200 in one gNB 100, the probability of occurrence (frequency of occurrence) of collisions in Msg 1 of the RA procedure can be reduced while the amount of resources used can be suppressed. That is, according to this operation example, resources can be efficiently utilized in Msg 1 of the RA procedure.

### (3.2.3.2) Operation Example 3-2

In this operation example, the gNB 100 may integrate multiple beams (SSB) as one group by explicitly notifying the UE 200 of a group of beams (SSB) sharing a RACH resource.

In this operation example, one of the following methods can be used as a method for allocating RACH resources to multiple beams (SSB) belonging to one group.
(Alt. 3-2-1) RACH resources can be allocated so that RACH preamble and RACH occurrence are shared among all beams (SSB) belonging to one group.
(Alt. 3-2-2) RACH resources can be allocated so that multiple beams (SSB) belonging to one group have shared resources that share RACH preamble and RACH occurrence, and dedicated resources that are dedicated to either RACH preamble or RACH occurrence.

In the case of (Alt. 3-2-2) above, for example, one RACH resource group can be explicitly configured in the prach-ConfigurationIndex and msg1-FDM of the RACH-ConfigGeneric information element (see FIG. 7), which is an information element described in Non-Patent Literature 1, the ratio of shared resources to dedicated resources in the one RACH resource group can be configured, and the one RACH resource group can be divided based on the ratio. Or, in the case of (Alt. 3-2-2) above, for example, the RACH resource group for shared resources and the RACH resource group for dedicated resources can be separately configured in the prach-ConfigurationIndex and msg1-FDM of the RACH-ConfigGeneric information element (see FIG. 7), which is an information element described in Non-Patent Literature 1.

In the above case of (Alt. 3-2-2), when the UE 200 determines that the RSRP of one beam (SSB) among the multiple beams (SSB) belonging to the same group is high with respect to the RSRP of the other beam (SSB), the RACH preamble may be transmitted using the RACH occurrences of the dedicated resource, instead of the RACH occurrences of the shared resource, in order to prevent interference. In the above RSRP determination, either the absolute value of the RSRP or the difference value from the reference value of the RSRP may be used as the threshold applied to the RSRP of the other beam (SSB).

In the above (Alt. 3-2-2) case, when the UE 200 determines that the number of retransmissions of the RACH preamble exceeds the threshold after failing to receive the RAR (Random Access Response) from the gNB 100, the RACH preamble may be transmitted using the RACH occurrences of the dedicated resource instead of the RACH occurrences of the shared resource.

Here, according to the provisions of Release 15 of the 3 GPP, the RACH preamble and the RACH occurrence are reserved by one beam (SSB) because, for example, the RACH resource is allocated as shown in FIG. 8.

In contrast, in the case of the above (Alt. 3-2-1), the RACH preamble and the RACH occurrence can be shared by two beams (SSB) by allocating the RACH resource as shown in FIG. 9, for example.

In the case of the above (Alt. 3-2-2), by allocating the RACH resource as shown in FIG. 10, for example, the RACH preamble can be dedicated by one beam (SSB), and the RACH preamble and the RACH occurrence can be shared by two beams (SSB).

In this example of operation, the UE 200 only needs to be configured to receive from the gNB 100 a number of beams belonging to one group (at radio signal transmission and reception unit 210) that share at least some of the resources available in random access, and to send to the gNB 100 (at radio signal transmission and reception unit 210) a random access preamble corresponding to the resource of one of the beams.

According to this example of operation, even if the gNB 100 receives, at the same resource, a number of RACH preambles corresponding to a number of mutually different beams (SSB) transmitted by spatial division multiplexing from the UE 200, the multiple RACH preambles can be detected individually. Therefore, according to this example of operation, when accommodating a number of UEs 200 in one gNB 100, the probability of occurrence (frequency of occurrence) of a collision in Msg 1 of the RA procedure can be reduced while suppressing the amount of resources used. That is, according to this example of operation, the resources in Msg 1 of the RA procedure can be efficiently used.

### (4) Operational Effects

According to the above embodiment, the following operation effects can be obtained.

A terminal (UE 200) receives from a radio base station (gNB 100) information including a first series length corresponding to a first subcarrier spacing (15 kHz, 30 kHz, 60 kHz or 120 kHz) and configure to a number greater than a first specified value (139), or information including a second series length corresponding to a second subcarrier spacing (either 1.25 kHz or 5 kHz) and configure to a number greater than a second specified value (839), and transmits to the radio base station a random access preamble having the first or second series length corresponding to the received information. Thus, the terminal can sufficiently avoid collisions in Msg1 of the RA procedure, for example, even when the number of RACH occurrences is small, and consequently resources can be efficiently utilized in Msg1 of the RA procedure.

Moreover, the terminal (UE 200) can receive information from the radio base station (gNB 100) including candidates of multiple formats (RACH preamble formats) usable in random access, select one format from among the candidates of the multiple formats included in the received information, and transmit the random access preamble corresponding to the one format to the radio base station. Therefore, the terminal can transmit the RACH preamble using, for example, different RACH preamble formats depending on the position in the cell, and as a result, resources can be efficiently utilized in Msg1 of the RA procedure.

Moreover, the terminal (UE 200) can select one format from among the candidates of the multiple formats (RACH preamble formats) that can be used in random access based on the measurement result obtained by measuring the value indicating the communication status with the radio base station (gNB 100). Therefore, the terminal can transmit the RACH preamble using a different RACH preamble format according to the communication status with the radio base station, for example, so that resources can be efficiently utilized in Msg 1 of the RA procedure.

The terminal (UE 200) also selects one format from among the candidates of the multiple formats available in random access (RACH preamble format) based on capability information indicating at least one capability that can affect the coverage of the radio base station (gNB 100). Thus, the terminal can transmit a RACH preamble using, for example, a different RACH preamble format depending on the extent of coverage of the radio base station, thereby efficiently utilizing resources in Msg1 of the RA procedure.

Moreover, the terminal (UE 200) can receive from the radio base station (gNB 100) a number of beams belonging to one group that shares at least some of the resources (RACH resources) available in random access, and transmit to the radio base station a random access preamble corresponding to the resource of one of the received multiple beams. Thus, the terminal can transmit the RACH preamble using the same resources as those used by other terminals, for example, so that the resources can be efficiently utilized in Msg 1 of the RA procedure.

### (5) Other Embodiments

Although the above description of the embodiment is not limited to the description of the embodiment, it is obvious to those skilled in the art that various modifications and improvements are possible.

In addition, the block diagram (FIG. 3) used for the description of the above embodiment shows blocks of functional units. Those functional blocks (structural components) can be realized by a desired combination of at least one of hardware and software. Means for realizing each functional block is not particularly limited. That is, each functional block may be realized by one device combined physically or logically. Alternatively, two or more devices separated physically or logically may be directly or indirectly connected (for example, wired, or wireless) to each other, and each functional block may be realized by these plural devices. The functional blocks may be realized by combining software with the one device or the plural devices mentioned above.

Functions include judging, deciding, determining, calculating, computing, processing, deriving, investigating, searching, confirming, receiving, transmitting, outputting, accessing, resolving, selecting, choosing, establishing, comparing, assuming, expecting, considering, broadcasting, notifying, communicating, forwarding, configuring, reconfiguring, allocating (mapping), assigning, and the like. However, the functions are not limited thereto. For example, the functional block (component) that makes transmission work is called a transmitting unit (transmission unit) or transmitter. In either case, as described above, the implementation method is not particularly limited.

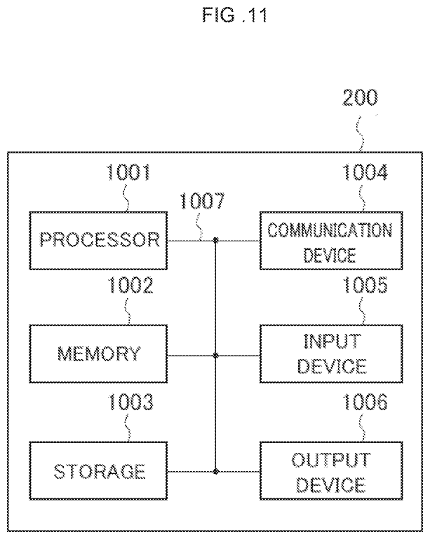

Furthermore, the UE 200 (the device) described above may function as a computer that performs processing of the radio communication method of this disclosure. FIG. 11 shows an example of the hardware configuration of the device. As shown in FIG. 11, the device may be configured as a computer device including a processor 1001, a memory 1002, a storage 1003, a communication device 1004, an input device 1005, an output device 1006 and a bus 1007, etc.

Furthermore, in the following explanation, the term “device” can be replaced with a circuit, device, unit, and the like. Hardware configuration of the device can be constituted by including one or plurality of the devices shown in the figure, or can be constituted by without including a part of the devices.

Each functional block of the device (see FIG. 3) is realized by any hardware element of the computer device or a combination of the hardware elements.

Moreover, the processor 1001 performs computing by loading a predetermined software (computer program) on hardware such as the processor 1001 and the memory 1002, and realizes various functions of the reference device by controlling communication via the communication device 1004, and controlling reading and/or writing of data on the memory 1002 and the storage 1003.

The processor 1001 controls the entire computer by, for example, operating the operating system. The processor 1001 may consist of a central processing unit (CPU) including interfaces with peripheral devices, controllers, arithmetic units, registers, etc.

Moreover, the processor 1001 reads a computer program (program code), a software module, data, and the like from the storage 1003 and/or the communication device 1004 into the memory 1002, and executes various processes according to the data. As a program, a program that causes the computer to perform at least some of the operations described in the above described embodiment is used. Alternatively, various processes explained above can be executed by one processor 1001 or can be executed simultaneously or sequentially by two or more processors 1001. The processor 1001 can be implemented by using one or more chips. Alternatively, the computer program can be transmitted from a network via a telecommunication line.

The memory 1002 is a computer readable recording medium and is configured, for example, with at least one of Read Only Memory (ROM), Erasable Programmable ROM (EPROM), Electrically Erasable Programmable ROM (EEPROM), Random Access Memory (RAM), and the like. The memory 1002 may be called a register, a cache, a main memory (main memory), etc. The memory 1002 can store programs (program code), software modules, etc., that can execute a method according to one embodiment of this disclosure.

The storage 1003 is a computer readable recording medium. Examples of the storage 1003 include an optical disk such as Compact Disc ROM (CD-ROM), a hard disk drive, a flexible disk, a magneto-optical disk (for example, a compact disk, a digital versatile disk, Blu-ray (Registered Trademark) disk), a smart card, a flash memory (for example, a card, a stick, a key drive), a floppy (Registered Trademark) disk, a magnetic strip, and the like. The storage 1003 can be called an auxiliary storage device. The recording medium can be, for example, a database including the memory 1002 and/or the storage 1003, a server, or other appropriate medium.

The communication device 1004 is hardware (transmission/reception device) capable of performing communication between computers via a wired and/or wireless network. The communication device 1004 is also called, for example, a network device, a network controller, a network card, a communication module, and the like.

The communication device 1004 includes a high-frequency switch, a duplexer, a filter, a frequency synthesizer, and the like in order to realize, for example, at least one of Frequency Division Duplex (FDD) and Time Division Duplex (TDD).

The input device 1005 is an input device (for example, a keyboard, a mouse, a microphone, a switch, a button, a sensor, and the like) that accepts input from the outside. The output device 1006 is an output device (for example, a display, a speaker, an LED lamp, and the like) that outputs data to the outside. Note that, the input device 1005 and the output device 1006 may be integrated (for example, a touch screen).

Each device such as a processor 1001 and a memory 1002 is connected by a bus 1007 for communicating information. The bus 1007 may be configured using a single bus or different buses for each device.

Furthermore, the device may be configured including hardware such as a microprocessor, a digital signal processor (DSP), an application specific integrated circuit (ASIC), a programmable logic device (PLD), a field programmable gate array (FPGA), etc., with which some or all of the functional blocks may be implemented. For example, the processor 1001 may be implemented by using at least one of these hardware.

In addition, notification of information is not limited to the mode/embodiment described in this disclosure and may be made using other methods. For example, notification of information may be carried out by physical layer signaling (e.g., Downlink Control Information (DCI), Uplink Control Information (UCI), higher layer signaling (e.g., RRC signaling, Medium Access Control (MAC) signaling, notification information (Master Information Block (MIB), System Information Block (SIB)), other signals or a combination thereof. Also, RRC signaling may be referred to as RRC messages, for example, RRC Connection Setup messages, RRC Connection Reconfiguration messages, etc.

Each of the above aspects/embodiments can be applied to at least one of Long Term Evolution (LTE), LTE-Advanced (LTE-A), SUPER 3G, IMT-Advanced, 4th generation mobile communication system (4G), 5th generation mobile communication system (5G), Future Radio Access (FRA), New Radio (NR), W-CDMA (Registered Trademark), GSM (Registered Trademark), CDMA2000, Ultra Mobile Broadband (UMB), IEEE 802.11 (Wi-Fi (Registered Trademark)), IEEE 802.16 (WiMAX (Registered Trademark)), IEEE 802.20, Ultra-WideBand (UWB), Bluetooth (Registered Trademark), a system using any other appropriate system, and a next-generation system that is expanded based on these. Further, a plurality of systems may be combined (for example, a combination of at least one of the LTE and the LTE-A with the 5G).

The processing procedures, sequences, flowcharts, etc., of each mode/embodiment described in this disclosure may be reordered as long as there is no conflict. For example, the method described in this disclosure uses an illustrative order to present elements of various steps and is not limited to the specific order presented.

The specific operation that is performed by the base station in the present disclosure may be performed by its upper node in some cases. In a network constituted by one or more network nodes having a base station, the various operations performed for communication with the terminal may be performed by at least one of the base station and other network nodes other than the base station (for example, MME, S-GW, and the like may be considered, but not limited thereto). In the above, an example in which there is one network node other than the base station is explained; however, a combination of a plurality of other network nodes (for example, MME and S-GW) may be used.

Information, signals (information and the like) can be output from an upper layer (or lower layer) to a lower layer (or upper layer). It may be input and output via a plurality of network nodes.

The input/output information can be stored in a specific location (for example, a memory) or can be managed in a management table. The information to be input/output can be overwritten, updated, or added. The information can be deleted after outputting. The inputted information can be transmitted to another device.

The determination may be made by a value (0 or 1) represented by one bit or by Boolean value (Boolean: true or false), or by comparison of numerical values (for example, comparison with a predetermined value).

Each aspect/embodiment described in this disclosure may be used alone, in combination, or switched over as practice progresses. In addition, notification of predetermined information (for example, notification of “being X”) is not limited to being performed explicitly, it may be performed implicitly (for example, without notifying the predetermined information).

Instead of being referred to as software, firmware, middleware, microcode, hardware description language, or some other name, software should be interpreted broadly to mean instruction, instruction set, code, code segment, program code, program, subprogram, software module, application, software application, software package, routine, subroutine, object, executable file, execution thread, procedure, function, and the like.

Further, software, instruction, information, and the like may be transmitted and received via a transmission medium. For example, when a software is transmitted from a website, a server, or some other remote source by using at least one of a wired technology (coaxial cable, fiber optic cable, twisted pair, Digital Subscriber Line (DSL), or the like) and a wireless technology (infrared light, microwave, or the like), then at least one of these wired and wireless technologies is included within the definition of the transmission medium.

Information, signals, or the like mentioned above may be represented by using any of a variety of different technologies. For example, data, instruction, command, information, signal, bit, symbol, chip, or the like that may be mentioned throughout the above description may be represented by voltage, current, electromagnetic wave, magnetic field or magnetic particle, optical field or photons, or a desired combination thereof.

It should be noted that the terms described in this disclosure and terms necessary for understanding the present disclosure may be replaced by terms having the same or similar meanings. For example, at least one of the channels and symbols may be a signal (signaling). Also, the signal may be a message. Also, a signal may be a message. Further, a component carrier (Component Carrier: CC) may be referred to as a carrier frequency, a cell, a frequency carrier, or the like.

The terms “system” and “network” used in the present disclosure can be used interchangeably.

Furthermore, the information, the parameter, and the like explained in the present disclosure can be represented by an absolute value, can be expressed as a relative value from a predetermined value, or can be represented by corresponding other information. For example, the radio resource can be indicated by an index.

The name used for the above parameter is not a restrictive name in any respect. In addition, formulas and the like using these parameters may be different from those explicitly disclosed in the present disclosure. Because the various channels (for example, PUCCH, PDCCH, or the like) and information element can be identified by any suitable name, the various names assigned to these various channels and information elements shall not be restricted in any way.

In the present disclosure, it is assumed that “base station (Base Station: BS),” “radio base station,” “fixed station,” “NodeB,” “eNodeB (eNB),” “gNodeB (gNB),” “access point,” “transmission point,” “reception point,” “transmission/reception point,” “cell,” “sector,” “cell group,” “carrier,” “component carrier,” and the like can be used interchangeably. The base station may also be referred to with the terms such as a macro cell, a small cell, a femtocell, or a pico cell.

The base station can accommodate one or more (for example, three) cells (also called sectors). In a configuration in which the base station accommodates a plurality of cells, the entire coverage area of the base station can be divided into a plurality of smaller areas. In each such a smaller area, communication service can be provided by a base station subsystem (for example, a small base station for indoor use (Remote Radio Head: RRH)).

The term “cell” or “sector” refers to a part or all of the coverage area of a base station and/or a base station subsystem that performs communication service in this coverage.

In the present disclosure, the terms “mobile station (Mobile Station: MS),” “user terminal,” “user equipment (User Equipment: UE),” “terminal” and the like can be used interchangeably.

The mobile station is called by the persons skilled in the art as a subscriber station, a mobile unit, a subscriber unit, a radio unit, a remote unit, a mobile device, a radio device, a radio communication device, a remote device, a mobile subscriber station, an access terminal, a mobile terminal, a radio terminal, a remote terminal, a handset, a user agent, a mobile client, a client, or with some other suitable term.

At least one of a base station and a mobile station may be called a transmitting device, a receiving device, a communication device, or the like. Note that, at least one of a base station and a mobile station may be a device mounted on a moving body, a moving body itself, or the like. The mobile body may be a vehicle (For example, cars, airplanes, etc.), an unmanned mobile body (For example, drones, self-driving cars, etc.) or a robot (manned or unmanned). At least one of a base station and a mobile station can be a device that does not necessarily move during the communication operation. For example, at least one of a base station and a mobile station may be an Internet of Things (IoT) device such as a sensor.

The base station in this disclosure may also be read as a mobile station (user terminal, hereinafter the same). For example, each mode/embodiment of this disclosure may be applied to a configuration in which communication between a base station and a mobile station is replaced with communication between multiple mobile stations (For example, it may be called Device-to-Device (D2D), Vehicle-to-Everything (V2X), etc.). In this case, the mobile station may have the function of the base station. In addition, words such as “up” and “down” may be replaced with words corresponding to communication between terminals (For example, “side”). For example, terms an uplink channel, a downlink channel, or the like may be read as a side channel.

Similarly, mobile stations in this disclosure may be replaced with base stations. In this case, the base station may have the function of the mobile station.

A radio frame may be composed of one or more frames in the time domain. Each frame or frames in the time domain may be referred to as a subframe. A subframe may be further configured by one or more slots in the time domain. Subframes may have a fixed length of time (For example, 1 ms) independent of numerology.

Numerology may be a communication parameter applied to at least one of transmission and reception of a certain signal or channel. The numerology can include one among, for example, subcarrier spacing (SubCarrier Spacing: SCS), bandwidth, symbol length, cyclic prefix length, transmission time interval (Transmission Time Interval: TTI), number of symbols per TTI, radio frame configuration, a specific filtering process performed by a transceiver in the frequency domain, a specific windowing process performed by a transceiver in the time domain, and the like.

The slot may be configured with one or a plurality of symbols (Orthogonal Frequency Division Multiplexing (OFDM)) symbols, Single Carrier Frequency Division Multiple Access (SC-FDMA) symbols, etc.) in the time domain. A slot may be a unit of time based on the numerology.

A slot may include a plurality of minislots. Each minislot may be configured with one or more symbols in the time domain. A minislot may also be called a subslot. A minislot may be composed of fewer symbols than slots. A PDSCH (or PUSCH) transmitted in units of time larger than a minislot may be called a PDSCH (or PUSCH) mapping type A. PDSCH (or PUSCH) transmitted using a minislot may be referred to as PDSCH (or PUSCH) mapping type B.

Each of the radio frame, subframe, slot, minislot, and symbol represents a time unit for transmitting a signal. Different names may be used for the radio frame, subframe, slot, minislot, and symbol.

For example, one subframe may be called a transmission time interval (TTI), a plurality of consecutive subframes may be called TTI, and one slot or one minislot may be called TTI. That is, at least one of the subframes and TTI may be a subframe (1 ms) in an existing LTE, may have a duration shorter than 1 ms (For example, 1-13 symbols), or may have a duration longer than 1 ms. Note that, a unit representing TTI may be called a slot, a minislot, or the like instead of a subframe.

Here, TTI refers to the minimum time unit of scheduling in radio communication, for example. Here, TTI refers to the minimum time unit of scheduling in radio communication, for example. For example, in the LTE system, the base station performs scheduling for allocating radio resources (frequency bandwidth, transmission power, etc. that can be used in each user terminal) to each user terminal in units of TTI. The definition of TTI is not limited to this.

The TTI may be a transmission time unit such as a channel-encoded data packet (transport block), a code block, or a code word, or may be a processing unit such as scheduling or link adaptation. When TTI is given, a time interval (for example, the number of symbols) in which a transport block, a code block, a code word, etc. are actually mapped may be shorter than TTI.

When one slot or one minislot is called TTI, one or more TTIs (that is, one or more slots or one or more minislots) may be the minimum scheduling unit. In addition, the number of slots (number of minislots) constituting the minimum time unit of the scheduling may be controlled.

TTI having a time length of 1 ms may be referred to as an ordinary TTI (TTI in LTE Rel. 8-12), a normal TTI, a long TTI, a normal subframe, a normal subframe, a long subframe, a slot, and the like. TTI shorter than the ordinary TTI may be referred to as a shortened TTI, a short TTI, a partial TTI (partial or fractional TTI), a shortened subframe, a short subframe, a minislot, a subslot, a slot, and the like.

In addition, a long TTI (for example, ordinary TTI, subframe, etc.) may be read as TTI having a time length exceeding 1 ms, and a short TTI (for example, shortened TTI) may be read as TTI having TTI length of less than the TTI length of the long TTI but TTI length of 1 ms or more.

The resource block (RB) is a resource allocation unit in the time domain and frequency domain, and may include one or a plurality of continuous subcarriers in the frequency domain. The number of subcarriers included in RB may be, for example, twelve, and the same regardless of the topology. The number of subcarriers included in the RB may be determined based on the neurology.

Also, the time domain of RB may include one or a plurality of symbols, and may have a length of 1 slot, 1 minislot, 1 subframe, or 1 TTI. Each TTI, subframe, etc. may be composed of one or more resource blocks.

Note that, one or more RBs may be called a physical resource block (Physical RB: PRB), a subcarrier group (Sub-Carrier Group: SCG), a resource element group (Resource Element Group: REG), PRB pair, RB pair, etc.

A resource block may be configured by one or a plurality of resource elements (Resource Element: RE). For example, one RE may be a radio resource area of one subcarrier and one symbol.

A bandwidth part (BWP) (which may be called a partial bandwidth, etc.) may represent a subset of contiguous common resource blocks (RBs) for a certain neurology in a certain carrier. Here, the common RB may be identified by an index of RBs relative to the common reference point of the carrier. PRB may be defined in BWP and numbered within that BWP.

BWP may include UL BWP (UL BWP) and DL BWP (DL BWP). One or a plurality of BWPs may be configured in one carrier for the UE.

At least one of the configured BWPs may be active, and the UE may not expect to send and receive certain signals/channels outside the active BWP. Note that “cell,” “carrier,” and the like in this disclosure may be read as “BWP.”

The above-described structures such as a radio frame, subframe, slot, minislot, and symbol are merely examples. For example, the number of subframes included in a radio frame, the number of slots per subframe or radio frame, the number of minislots included in a slot, the number of symbols and RBs included in a slot or minislot, the subcarriers included in RBs, and the number of symbols included in TTI, a symbol length, the cyclic prefix (CP) length, and the like can be changed in various manner.

The terms “connected,” “coupled,” or any variations thereof, mean any direct or indirect connection or coupling between two or more elements. Also, one or more intermediate elements may be present between two elements that are “connected” or “coupled” to each other. The coupling or connection between the elements may be physical, logical, or a combination thereof. For example, “connection” may be read as “access.” In the present disclosure, two elements can be “connected” or “coupled” to each other by using one or more wires, cables, printed electrical connections, and as some non-limiting and non-exhaustive examples, by using electromagnetic energy having wavelengths in the microwave region and light (both visible and invisible) regions, and the like.

The reference signal may be abbreviated as Reference Signal (RS) and may be called pilot (Pilot) according to applicable standards.

As used in the present disclosure, the phrase “based on” does not mean “based only on” unless explicitly stated otherwise. In other words, the phrase “based on” means both “based only on” and “based at least on.”

The “means” in the configuration of each apparatus may be replaced with “unit,” “circuit,” “device,” and the like.

Any reference to an element using a designation such as “first,” “second,” and the like used in the present disclosure generally does not limit the amount or order of those elements. Such designations can be used in the present disclosure as a convenient way to distinguish between two or more elements. Thus, the reference to the first and second elements does not imply that only two elements can be adopted, or that the first element must precede the second element in some or the other manner.

In the present disclosure, the used terms “include,” “including,” and variants thereof are intended to be inclusive in a manner similar to the term “comprising.” Furthermore, the term “or” used in the present disclosure is intended not to be an exclusive disjunction.

Throughout this disclosure, for example, during translation, if articles such as a, an, and the in English are added, in this disclosure, these articles shall include plurality of nouns following these articles.

As used in this disclosure, the terms “determining,” “judging” and “deciding” may encompass a wide variety of actions. “Judgment” and “decision” includes judging or deciding by, for example, judging, calculating, computing, processing, deriving, investigating, looking up, search, inquiry (e.g., searching in a table, database, or other data structure), ascertaining, and the like. In addition, “judgment” and “decision” can include judging or deciding by receiving (for example, receiving information), transmitting (for example, transmitting information), input (input), output (output), and access (accessing) (e.g., accessing data in a memory). In addition, “judgement” and “decision” can include judging or deciding by resolving, selecting, choosing, establishing, and comparing. That is, “judgment” and “determination” may include regarding some action as “judgment” and “determination.” Moreover, “judgment (decision)” may be read as “assuming,” “expecting,” “considering,” and the like.

In the present disclosure, the term “A and B are different” may mean “A and B are different from each other.” It should be noted that the term may mean “A and B are each different from C.” Terms such as “leave,” “coupled,” or the like may also be interpreted in the same manner as “different.”

Although the present disclosure has been described in detail above, it will be obvious to those skilled in the art that the present disclosure is not limited to the embodiments described in this disclosure. The present disclosure can be implemented as modifications and variations without departing from the spirit and scope of the present disclosure as defined by the claims. Therefore, the description of the present disclosure is for the purpose of illustration, and does not have any restrictive meaning to the present disclosure.

### EXPLANATION OF REFERENCE NUMERALS

10 radio communication system
20 NG-RAN
100 radio base station (gNB)
200 UE
210 radio signal transmission and reception unit
220 amplifier unit
230 modulation and demodulation unit
240 control signal and reference signal processing unit
250 encoding/decoding unit
260 data transmission and reception unit
270 control unit
1001 processor
1002 memory
1003 Storage
1004 communication device
1005 input device
1006 output device
1007 bus

1. A terminal comprising:
a reception unit that receives from a radio base station information including a first series length corresponding to a first subcarrier spacing and configure to a number greater than a first specified value, or information including a second series length corresponding to a second subcarrier spacing and configure to a number greater than a second specified value; and
a transmission unit that transmits to the radio base station a random access preamble having the first series length or the second series length corresponding to the information received by the reception unit.

2. A terminal comprising:
a reception unit that receives information from a radio base station including candidates of a plurality of formats that can be used in random access;
a control unit that selects one format from among the candidates of the plurality of formats included in the information received by the reception unit; and
a transmission unit that transmits a random access preamble corresponding to the one format selected by control unit to the radio base station.

3. The terminal according to claim 2, wherein the control unit selects one of the plurality of format candidates based on the measurement result obtained by measuring a value indicating the communication status with the radio base station.

4. The terminal according to claim 2, wherein the control unit selects one of the multiple format candidates based on capability information indicating at least one capability that can affect a coverage of the radio base station.

5. A terminal comprising:
a reception unit that receives a plurality of beams from a radio base station that belong to one group that shares at least some of the resources available in random access; and
a transmission unit that transmits a random access preamble corresponding to the resources of one of the plurality of beams received by the reception unit to the radio base station.
